(19) United States
(12) Patent Application Publication
(10) Pub. No.: US 2026/0100430 A1
(43) Pub. Date: Apr. 9, 2026

(54) SENSING ASSEMBLY AND BATTERY MODULE COMPRISING THE SAME

(71) Applicant: SK On Co., Ltd., Seoul (KR)

(72) Inventors: Eun Jeong CHOI, Daejeon (KR); Gang U LEE, Daejeon (KR); Eung Ho LEE, Daejeon (KR); Jae Il HWANG, Daejeon (KR)

(21) Appl. No.: 19/386,031

(22) Filed: Nov. 11, 2025

Related U.S. Application Data
(63) Continuation of application No. 17/060,184, filed on Oct. 1, 2020.

(30) Foreign Application Priority Data
Oct. 31, 2019 (KR) 10-2019-0137354

(51) Int. Cl. H01M 10/48; H01M 50/20; H01M 50/528; H01M 50/543

(52) U.S. Cl. CPC H01M 10/482; H01M 50/20; H01M 50/528; H01M 50/543

(57) ABSTRACT

Provided are a more easily assembled sensing assembly and a battery module comprising the same by having a simplified process through a connection structure between a terminal portion and a signal connection portion which are respectively coupled to a case and lead portions of a battery cell, thereby solving a problem that an additional process is necessary for a conventional sensing block to be coupled to leads of the secondary batteries after being coupled to a case.

### CROSS-REFERENCE TO RELATED APPLICATIONS

This application is a continuation of U.S. patent application Ser. No. 17/060,184 filed on Oct. 1, 2020, which claims priority under 35 U.S.C. § 119 to Korean Patent Application No. 10-2019-0137354, filed on Oct. 31, 2019, in the Korean Intellectual Property Office, the disclosure of which is incorporated herein by reference in its entirety.

### TECHNICAL FIELD

The following disclosure relates to a sensing assembly and a battery module comprising the same.

### BACKGROUND

A battery may be used as a power source for many products in modern times, and may be collectively referred to as a physical battery and a chemical battery, but in general, may be collectively referred to as the chemical battery. Here, the battery may be roughly divided into a primary battery and a secondary battery. The primary battery may refer to a battery which is operated only with a discharge function and thus unable to be repeatedly used, and the secondary battery may refer to a semi-permanent chemical battery which is able to be charged and discharged and may thus be repeatedly used.

Such a secondary battery has been a core technology used in an electronic device such as a laptop computer, a personal computer (PC) and a mobile communication terminal, and has become more important as an electric vehicle and a fuel cell vehicle become more popular in recent years. Here, the secondary battery may be roughly divided into a cylindrical type, a square type and a pouch type. In addition, the secondary batteries may be stacked on top of each other to form an electrode assembly, the electrode assembly may be formed as a battery cell using an exterior material, and the plurality of battery cells may be accommodated in a case to be provided as a battery pack.

Here, as disclosed in Patent Document below and the like, voltage of the secondary battery may be measured for voltage balancing between the plurality of secondary batteries accommodated in the battery pack or for measuring a state of each secondary battery cell. Accordingly, the following description describes a battery module including a component for measuring the voltage of a conventional secondary battery with reference to FIG. 1.

As shown in FIG. 1, the conventional battery module may include a cell assembly 1 including a plurality of secondary batteries, an upper housing 2 coupled to the cell assembly, and sensing blocks 3 including bus bars coupled to electrode leads of the secondary batteries, respectively. Here, it is a main task to more easily assemble such a battery module including the sensing bus bars. There has been a conventional attempt to solve this task through a sliding coupling between the upper housing 2 and the sensing blocks 3 and through the pair of sensing blocks 3 having a variable length therebetween.

However, the battery module having such a configuration may have a wide volume, and may thus have low energy efficiency per its volume. In addition, such a battery module may require an additional process of coupling the upper housing 2 and the sensing blocks 3 to each other before being entirely assembled, and it may thus be somewhat difficult to couple respective sensing blocks 3 to the leads of the secondary batteries due to the upper housing already disposed.

### RELATED ART DOCUMENT

### Patent Document

KR 10-2018-0135701 A (Dec. 21, 2018)

### SUMMARY

An embodiment of the present disclosure is directed to providing a more easily assembled sensing assembly which allows terminal portions respectively coupled to lead portions of a battery cell and a signal connection portion aligning voltage information measured at electrodes which are in opposite directions on one surface of the battery cell to be attached to and detached from each other, and a battery module comprising the same.

Another embodiment of the present disclosure is directed to providing a sensing assembly having an easier electrical connection by having the terminal portions which each include a sensing board having a connection terminal positioned thereon and the signal connection portion which includes connection terminals to allow the signal connection portion to be attached to and detached from the connection terminals, and a battery module comprising the same.

In one general aspect, a sensing assembly for a battery module including a plurality of battery cells, includes: a pair of terminal portions respectively coupled to first and second lead portions of the battery cell to measure voltage information of the first and second lead portions protruding toward opposite sides of the battery cell; and a signal connection portion transmitting voltage information measured at the one terminal portion to the other terminal portion, wherein the signal connection portion is attached to and detached from the pair of terminal portions. The terminal portions are configured to couple to the first and second lead portions of the battery cell by moving from both sides of the battery cell, and the signal connection portion is configured to attach or detach with the terminal portions by moving in a direction different from the direction in which the terminal portions move.

In addition, the pair of terminal portions includes a pair of sensing boards each having a connection terminal thereon, and the signal connection portion may include first and second connection terminals respectively connected to the connection terminals of the pair of terminal portions and a sensing wire electrically connecting the first and second connection terminals to each other.

In addition, a connection case having an insertion groove may be disposed on one surface of the battery cell, and a sensing wire of the signal connection portion may be accommodated in the insertion groove of the connection case.

In addition, the signal connection portion may further include a sealing portion sealing the outside of the sensing wire, the sealing portion being fixed on the connection case.

In addition, the pair of terminal portions may include a pair of housings respectively coupled to the first and second lead portions of the battery cell, the pair of housings each including a lead coupling slit open in the opposite directions and into which the first lead portion or the second lead portion is inserted, the first lead portion being inserted into the lead coupling slit of the one housing, and the second lead portion being inserted into the lead coupling slit of the other housing.

In addition, the connection case having a first fastening member may be disposed on upper surface of the battery cell, and a second fastening member may be disposed at an upper end of each of the pair of housings to be coupled to the first fastening member of the connection case.

In addition, the pair of terminal portions may further include: a pair of bus bars respectively fixed and coupled to the pair of housings and electrically connected to the first and second lead portions, respectively; and the pair of sensing boards respectively fixed and coupled to the pair of housings and receiving the voltage information from the pair of bus bars, respectively, and the signal connection portion may electrically connect the pair of sensing boards to each other to allow the voltage information measured at the one sensing board to be transmitted to the other sensing board.

In addition, the bus bar and the sensing board may be soldered to each other.

In addition, the pair of sensing boards may each have the connection terminal positioned thereon, and the signal connection portion may include the first connection terminal connected to the one sensing board, the second connection terminal connected to the other sensing board and the sensing wire connecting the first and second connection terminals to each other.

In addition, the sensing board may be made of a printed circuit board.

In another general aspect, a battery module includes: battery cells each having first and second lead portions protruding in opposite directions; a pair of lead cases respectively disposed on opposite sides of the battery cell; a pair of terminal portions respectively disposed between the one lead case and the first lead portion and between the other lead case and the second lead portion, to measure voltage information of each of the first and second lead portions; and a signal connection portion electrically connecting the one terminal portion and the other terminal portion to each other.

In addition, the battery module of the present disclosure may further include a connection case disposed on one surface other than both side surfaces of the battery cell, wherein the signal connection portion may include first and second connection terminals respectively connected to the pair of the terminal portions and a sensing wire connecting the first and second connection terminals to each other and accommodated in the connection case. The terminal portions are configured to couple to the first and second lead portions of the battery cell by moving from both sides of the battery cell, the connection case is coupled to the terminal portions by moving in a direction different from the direction in which the terminal portions move, the signal connection portion is configured to attach or detach with the terminal portions while the connection case is coupled to the terminal portions, and the lead case is fixedly coupled and surrounds the terminal portions after the connection case and terminal portions are coupled to each other.

In addition, the connection case may include an insertion groove having a predetermined depth and extending in the opposite directions, and the signal connection portion may further include a sealing portion sealing the sensing wire accommodated in the insertion groove.

Other features and aspects are apparent from the following detailed description, the drawings and the claims.

### BRIEF DESCRIPTION OF THE DRAWINGS

FIG. 1 is an exploded perspective view of a battery module according to the prior art.

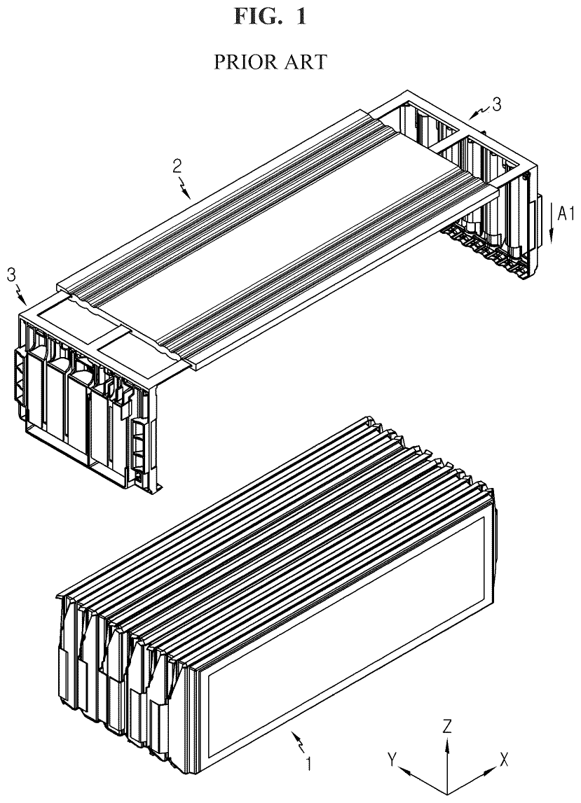

FIG. 2 is a perspective view of a battery module according to an embodiment of the present disclosure.

FIG. 3 is an exploded perspective view of the battery module according to an embodiment of the present disclosure.

FIG. 4 is an exploded perspective view of a connection case and a signal connection portion according to an embodiment of the present disclosure.

FIG. 5 is an exploded perspective view of a battery cell and a terminal portion according to an embodiment of the present disclosure.

FIG. 6 is a front view of the terminal portion according to an embodiment of the present disclosure.

FIG. 7 is a front view of the terminal portion from which the connection case and the signal connection portion are removed according to an embodiment of the present disclosure.

### DETAILED DESCRIPTION OF EMBODIMENTS

Hereinafter, a sensing assembly and a battery module comprising the same according to embodiments of the present disclosure are described in detail with reference to the accompanying drawings. The accompanying drawings are provided by way of example to sufficiently transfer the idea of the present disclosure to those skilled in the art to which the present disclosure pertains. Therefore, the present disclosure is not limited to the drawings to be provided below, but may be implemented in other forms.

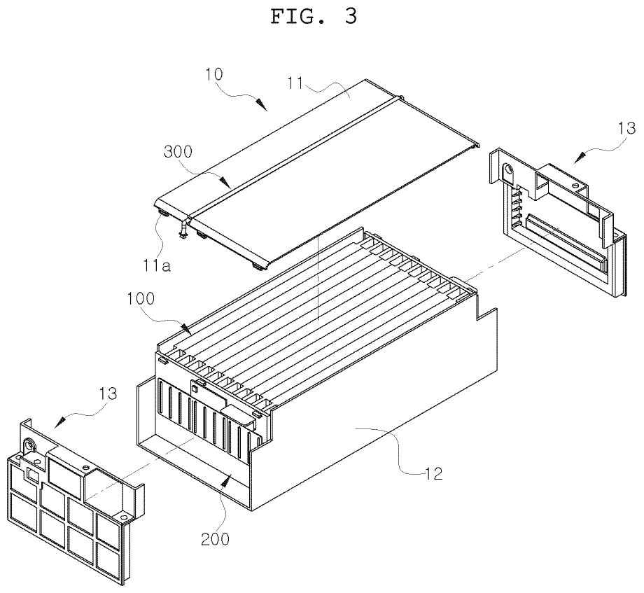

Hereinafter, for convenience of explanation, forward and backward directions may be defined as follows: the forward direction may refer to a direction from a battery cell 100 to be described below toward one lead case 13 (as shown in the lower left portion of FIG. 3); and the backward direction may refer to the opposite direction, i.e. a direction from the battery cell 100 toward the other lead case 13 (as shown in the upper right portion of FIG. 3). In addition, upward and downward directions may be defined as follows: the upward direction may refer to a direction from the battery cell 100 toward a connection case 11 (as shown in the upward portion of FIG. 3); and the downward direction may refer to the opposite direction (as shown in the downward portion of FIG. 3). In addition, left and right directions may be defined as follows: the left direction may refer to a direction from the battery cell 100 toward one side case 12 (as shown in the upper left portion of FIG. 3); and the right direction may refer to the opposite direction, i.e. a direction from the battery cell 100 toward the other side case 12 (as shown in the lower right portion of FIG. 3).

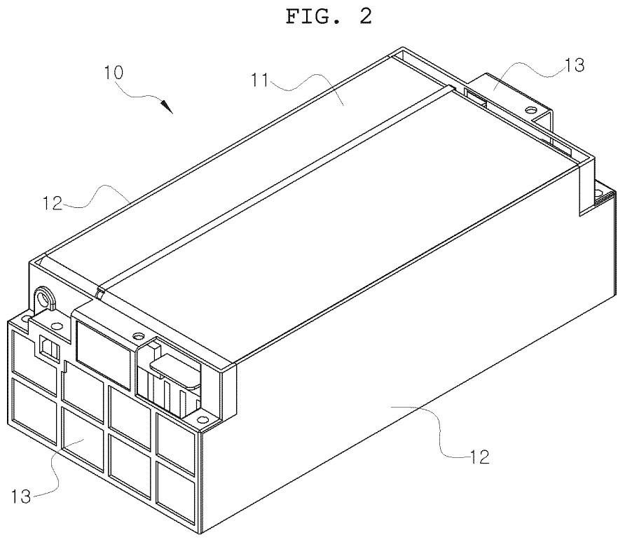

FIGS. 2 and 3 respectively show a sensing assembly and a battery module comprising the same according to an embodiment of the present disclosure: FIG. 2 is a perspective view of a battery module 10; and FIG. 3 is an exploded perspective view of the battery module 10.

First, referring to FIG. 2, the battery module 10 of the present disclosure, in which the battery cell 100 has a plurality of secondary batteries accommodated therein, may include: the pair of lead cases 13 disposed on respective positions to be spaced apart from each other in the forward and backward directions from a position where leads of the secondary batteries included in the battery cell 100 are arranged; and the connection case 11 and the side cases 12 respectively disposed on the other surfaces other than the positions on which the lead cases 13 are disposed. Here, in case of having a rectangular parallelepiped shape, the battery module 10 may include respective pairs of the connection cases 11 and the side cases 12.

Next, referring to FIG. 3, the battery module 10 of the present disclosure may have the battery cell 100 accommodated therein as described above, and may further include a pair of terminal portions 200 respectively coupled to lead portions of the battery cell 100, protruding in the forward and backward directions. In addition, a signal connection portion 300 may be disposed on the connection case 11, and here, the signal connection portion 300 may be connected to the pair of terminal portions 200 to transmit voltage information measured at the one terminal portion 200 to the other terminal portion 200.

Here, the connection case 11 may include a first fastening member 11a, and thus be fastened to the terminal portion 200. In addition, the lead case 13 may be coupled and fixed to the terminal portion 200 while surrounding the terminal portion 200 in case that the connection case 11 and the terminal portion 200 are fastened to each other.

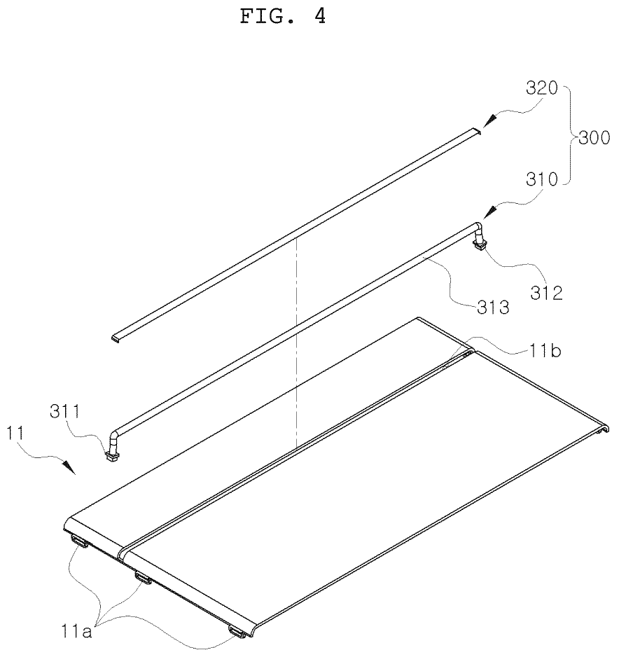

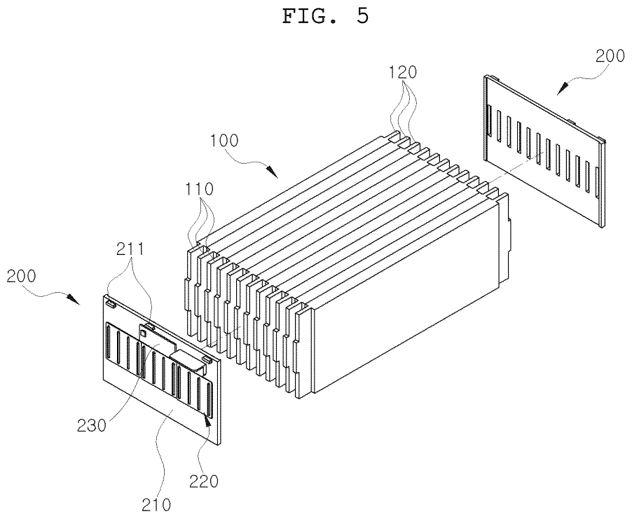

FIGS. 4 and 5 respectively show the sensing assembly and the battery module comprising the same according to an embodiment of the present disclosure: FIG. 4 is an exploded perspective view of a connection case 11 and a signal connection portion 300; and FIG. 5 is an exploded perspective view of a battery cell 100 and a terminal portion 200.

First, referring to FIG. 4, an insertion groove 11b having a predetermined depth may be formed in an outer surface of the connection case 11, and may extend in a shape of a groove in the forward and backward directions In addition, the signal connection portion 300 may include a wire portion 310 which is disposed to align lead information of a battery cell to one surface of the battery cell and a sealing portion 320 which seals the wire portion 310. The wire portion 310 may include a sensing wire 313, which is inserted into the insertion groove 11b, and first and second connection terminals 311 and 312, which are disposed at opposite ends of the sensing wire 313, respectively. In addition, the sealing portion 320 may be non-conductive like an insulating tape and may be configured to be fixed on the connection case 11, thereby preventing the sensing wire 313 from being exposed to the outside. Here, an area formed by the depth and width of the insertion groove 11b of the connection case 11 may be configured to correspond to or be greater than a cross-sectional area of the sensing wire 313.

In order to explain this configuration more clearly, it may be assumed that the connection case 11 is disposed to seal an upper portion of the battery cell. The sensing wire 313 of the wire portion 310 may be accommodated in the insertion groove 11b of the connection case 11, and the sealing portion 320 may be disposed on the sensing wire 313 to prevent the sensing wire 313 from being exposed to the outside. In addition, the insertion groove 11b may be open in the forward and backward directions, and the opposite ends of the sensing wire 313 may be bent downward, respectively, and the first and second connection terminals 311 and 312 may thus be disposed to face downward, respectively.

In addition, first fastening members 11a may be disposed at respective corners in the forward and backward directions of the connection case 11 as described above, and the plurality of the first fastening members 11a may also be disposed in the left and right directions. In addition, as shown in FIG. 4, a position where the insertion groove 11b is open and a position on which one of the plurality of first fastening members 11a is disposed may be different from each other. However, in some cases, the position where the insertion groove 11b is open and the position on which one of the plurality of first fastening members 11a is disposed may be the same as each other.

Next, referring to FIG. 5, as described above in the present disclosure, a first lead portion 110 and a second lead portion 120 may protrude in the forward and backward directions of the battery cell 100. Here, the first lead portion 110 and the second lead portion 120 may each have a shape in which the plurality of leads of the secondary batteries are arranged. In addition, the pair of terminal portions 200 of the present disclosure may be respectively coupled to the first lead portion 110 and the second lead portion 120.

Here, the terminal portion 200 of the present disclosure may include a housing 210, a bus bar 220 and a sensing board 230. Here, the terminal portions 200 may each have a structure symmetrical to each other, and this structure is described more clearly through the terminal portion 200 coupled to the first lead portion 110.

The housing 210 may have a through-slit, into which the first lead portion 110 may be inserted, and a second fastening member 211 disposed at an upper end of the housing 210 and fastened to the first fastening member 11a of the connection case 11 described above. Here, the plurality of the second fastening members 211 may also be disposed in the left and right directions, and thus be coupled to the plurality of first fastening members 11a. Here, the housing 210 may be made of non-conductive material.

The bus bar 220 may be coupled to the housing 210, that is, may be coupled to a rear surface of the housing 210 opposing a surface of the housing 210 on which the battery cell 100 is disposed. In addition, the bus bar 220 may be in contact with and electrically connected to the first lead portion 110 penetrating through the housing 210.

Further, the bus bar 220 may be connected to the sensing board 230 and may be configured to transmit voltage information measured at the first lead portion 110 to the sensing board 230. Accordingly, in the present disclosure, voltage information measured at the first lead portion 110 and the second lead portion 120 may be transmitted to the respective sensing boards 230 of the pair of terminal portions 200.

Here, in the present disclosure, the first and second connection terminals 311 and 312 of the signal connection portion 300 described above may be connected to the respective sensing boards 230 of the pair of terminal portions 200. In addition, the voltage information may be transmitted from one sensing board 230 to the other sensing board 230, and the voltage information may thus be positioned on one of opposite surfaces in the forward and backward directions of the battery module. Here, the voltage information positioned on the one surface may be connected to a battery management system (BMS) or a separate control device and thus transmitted to the outside of the battery module.

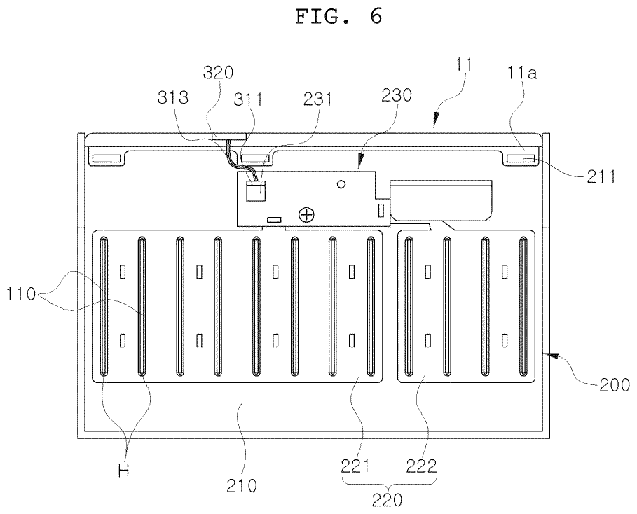

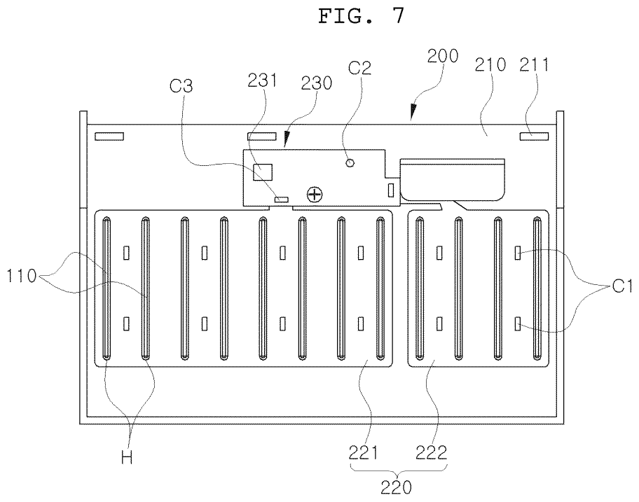

FIGS. 6 and 7 respectively show the sensing assembly and the battery module comprising the same according to an embodiment of the present disclosure: FIG. 6 is a front view of the terminal portion 200; and FIG. 7 is a view in which the connection case 11 and the signal connection portion 300 are removed from FIG. 6.

Referring to FIGS. 6 and 7, the terminal portion 200 coupled to the first lead portion 110 may include the sensing board 230 having a connection terminal 231 positioned thereon. In addition, the connection terminal 231 may be fastened and connected to the first connection terminal 311 disposed at the one end of the sensing wire 313. Here, although not shown, the second connection terminal 312 disposed at the other end of the sensing wire 313 may also be fastened to the connection terminal 231 of the terminal portion 200 coupled to the second lead portion 120. In addition, the connection terminals 311 and 312 and the connection terminals 231 may be attached to and detached from each other, respectively, in a connector type, and may thus be more easily assembled and replaced.

The first fastening member 11a of the connection case 11 may include a groove, and the second fastening member 211 of the housing 210 may protrude. Therefore, the second fastening member 211 may be inserted and fixed to the groove of the first fastening member 11a.

The bus bar 220 may include a plurality of unit bus bars including a first bus bar 221 and a second bus bar 222 respectively coupled to the first lead portion 110 having the plurality of leads of the secondary batteries. In addition, the unit bus bar may be fixed and coupled to the housing 210 through a first coupling portion C1 positioned on an outer surface of the housing 210. In addition, the sensing board 230 may also be fixed and coupled to the housing 210 through a second coupling portion C2 positioned on the outer surface of the housing 210, and the bus bar 220 may be coupled to the sensing board 230 through a third coupling portion C3. Here, in case of including the plurality of unit bus bars, the bus bar 220 may be coupled to the sensing board 230 through the third coupling portion C3 of each unit bus bar to be connected to a printed circuit of the sensing board 230.

Here, the first coupling portion C1, the second coupling portion C2 and the third coupling portion C3 may each be formed by one of several methods such as welding, bonding and fitting. Here, the third coupling portion C3 connecting the bus bar 220 and the sensing board 230 to each other may be formed by soldering to maintain a state in which the bus bar 220 and the sensing board 230 are electrically connected to each other.

In addition, a lead coupling slit H may penetrate through the housing 200, and the first lead portion 110 may thus pass through the lead coupling slit H to be connected to the bus bar 220. In addition, although not shown, the second lead portion 120 may also penetrate through the housing 210 disposed in the backward direction to be connected to the bus bar 220 in the backward direction.

In the sensing assembly of the present disclosure, which has the above configuration, and the battery module comprising the same, the battery cell having the electrodes which are in opposite directions, may transmit a measured voltage signal to the respective sensing boards disposed in the forward and backward directions through the respective bus bars, and the signal connection portion connecting the signal from the one sensing board to the other sensing board may be configured to be attached to and detached from each of the terminal portions. In this manner, the battery module may be more easily assembled.

In addition, the present disclosure may provide a product having a smaller size by allowing both the bus bar and the sensing board to be coupled to each of the pair of housings coupled to the lead portions of the battery cell having the electrodes which are in the opposite directions, and may also provide the sensing assembly having improved structural stability and a battery module comprising the same.

Hereinabove, the present disclosure is described by specific exemplary embodiments and the accompanying drawings. However, the present disclosure is not limited to the abovementioned exemplary embodiments. Various modifications and changes may be made by those skilled in the art to which the present disclosure pertains from this description. Therefore, the spirit of the present disclosure needs to be understood by the claims and all of modifications equal or equivalent to the claims are intended to fall within the scope and spirit of the present disclosure.

What is claimed IS:

1. A sensing assembly for a battery module including a plurality of battery cells, comprising:
a first terminal portion including a first sensing board configured to measure voltage information of a first lead portion protruding from one side of the battery cell;
a second terminal portion including a second sensing board configured to measure voltage information of a second lead portion protruding from the other side of the battery cell; and
a signal connection portion electrically connecting the first and second sensing boards to each other so as to transmit voltage information measured from one of the first and second sensing boards to the other.

2. The sensing assembly for a battery module of claim 1, wherein a pair of terminal portions includes the first terminal portion and the second terminal portion, the pair of terminal portions includes a pair of sensing boards each having a connection terminal thereon, and
the signal connection portion includes first and second connection terminals respectively connected to the connection terminals of the pair of terminal portions and a sensing wire electrically connecting the first and second connection terminals to each other.

3. The sensing assembly for a battery module of claim 2, wherein a connection case having an insertion groove is disposed on one surface of the battery cell, and a sensing wire of the signal connection portion is accommodated in the insertion groove of the connection case.

4. The sensing assembly for a battery module of claim 3, wherein the signal connection portion further includes a sealing portion sealing the outside of the sensing wire, the sealing portion being fixed on the connection case.

5. The sensing assembly for a battery module of claim 1, wherein a pair of terminal portions includes the first terminal portion and the second terminal portion, the pair of terminal portions includes a pair of housings respectively coupled to the first and second lead portions of the battery cell,
the pair of housings each including a lead coupling slit into which the first lead portion or the second lead portion is inserted,
the first lead portion being inserted into the lead coupling slit of the one housing, and
the second lead portion being inserted into the lead coupling slit of the other housing.

6. The sensing assembly for a battery module of claim 5, wherein the connection case having a first fastening member is disposed on an upper surface of the battery cell, and a second fastening member is disposed at an upper end of each of the pair of housings to be coupled to the first fastening member of the connection case.

7. The sensing assembly for a battery module of claim 5, wherein the pair of terminal portions further includes:
a pair of bus bars respectively fixed and coupled to the pair of housings and electrically connected to the first and second lead portions, respectively,
wherein the pair of sensing boards is respectively fixed and coupled to the pair of housings and receives the voltage information from the pair of bus bars, respectively, and
wherein the signal connection portion electrically connects the pair of sensing boards to each other to allow the voltage information measured at the one sensing board to be transmitted to the other sensing board.

8. The sensing assembly for a battery module of claim 7, wherein the bus bar and the sensing board are soldered to each other.

9. The sensing assembly for a battery module of claim 7, wherein the pair of sensing boards each has the connection terminal positioned thereon, and
the signal connection portion includes the first connection terminal connected to the one sensing board, the second connection terminal connected to the other sensing board and the sensing wire connecting the first and second connection terminals to each other.

10. The sensing assembly for a battery module of claim 7, wherein the sensing board is made of a printed circuit board.

11. A battery module comprising:
battery cells each having first and second lead portions protruding in opposite directions;
a pair of lead cases respectively disposed on opposite sides of the battery cell;
a pair of terminal portions respectively disposed between the one lead case and the first lead portion and between the other lead case and the second lead portion, to measure voltage information of each of the first and second lead portions; and
a signal connection portion electrically connecting the one terminal portion and the other terminal portion to each other.

12. The battery module of claim 11, further comprising a connection case disposed on one surface other than both side surfaces of the battery cell,
wherein the signal connection portion includes first and second connection terminals respectively connected to the pair of the terminal portions and a sensing wire connecting the first and second connection terminals to each other and accommodated in the connection case.

13. The battery module of claim 12,
wherein the connection case includes an insertion groove having a predetermined depth and extending in the opposite directions, and
the signal connection portion further includes a sealing portion sealing the sensing wire accommodated in the insertion groove.
